(19) United States
(12) Patent Application Publication
(10) Pub. No.: US 2009/0244932 A1
(43) Pub. Date: Oct. 1, 2009

(54) Synchronous Rectifying Apparatus and Forward Synchronous Converter

(75) Inventor: Chun-Ming Lin, Hsinchu City (TW)

Correspondence Address: NIKOLAI & MERSEREAU, P.A., 900 SECOND AVENUE SOUTH, SUITE 820, MINNEAPOLIS, MN, 55402, US

(73) Assignee: NIKO SEMICONDUCTOR CO., LTD., Taipei (TW)

(21) Appl. No.: 12/191,589

(22) Filed: Aug. 14, 2008

(30) Foreign Application Priority Data
Mar. 31, 2008 (TW) 97111639

(51) Int. Cl. H02M 3/335

(52) U.S. Cl. 363/21.06

(57) ABSTRACT

A synchronous rectifying apparatus suitable for use in a forward synchronous converter having a transforming unit with a primary and secondary side, and a first and second rectifying switches coupled to the secondary side is provided. The synchronous rectifying apparatus has a condition detecting unit and a synchronous rectifying controller. The condition detecting unit; coupled to the secondary side of the transforming unit, for detecting if the operation condition of the forward synchronous converter is at boundary between discontinuous current mode and continuous current mode or under discontinuous current mode based on the rising slope of the secondary side voltage of the transforming unit. If so, the condition detecting unit outputs a reset signal. The synchronous rectifying controller, coupled to the secondary side of the transforming unit and the condition detecting unit, to turn off the second rectifying switch for a predetermined time period in response to the reset signal.

### BACKGROUND OF THE INVENTION

1. Field of the Invention

The present invention is related to a synchronous rectifying apparatus and a forward synchronous converter, and more particular to a synchronous rectifying apparatus that is utilized to detect the boundary between continuous current mode (CCM) and discontinuous current mode (DCM) according to the rising slope of the secondary side voltage of the forward synchronous converter, and a forward synchronous converter that utilizes the above mentioned synchronous rectifying apparatus.

2. Description of Related Art

FIG. 1 is a schematic diagram showing a forward converter of the prior art. The forward converter includes a transformer T1, whose primary side is coupled to an input power source VIN provided by a pre-stage circuit, a pulse width modulator PWM, an input filter capacitor C1, a starting resistor R1, a starting capacitor C2, a current detection resistor R2, a rectifier diode D1, and a transistor switch Q1, which is controlled by the pulse width modulator PWM. The secondary side of the transformer T1 includes two output rectifier diodes D2, and D3, an inductor L, an output filter capacitor C3, and a voltage detector 10 composed of resistors R3 and R4.

Regarding the above mentioned forward converter, when the converter circuit initially starts, the input power source VIN begins charging the starting capacitor C2 through the starting resistor R1. Afterward, when the starting capacitor C2 has been charged to the voltage level capable to initiate the pulse width modulator PWM, the pulse width modulator PWM begins to operate. The pulse width modulator PWM adjusts the duty cycle of an output control signal according to the detection signal indicative of the output voltage VO, generated by the voltage detector 10, and also according to the detection signal indicative of the input current, generated by the current detection resistor R2, so as to vary the on-off time ratio of the transistor switch Q1, i.e. the duty cycle of the output control signal. When the output voltage VO is lower than a predetermined voltage level, the duty cycle of the output control signal would be increased, whereas, when output voltage VO is higher than a predetermined voltage level, the duty cycle of the output control signal would be decreased. Thus, a stable output voltage VO is achieved.

When the, transistor switch Q1 is turned-on, the input power source VIN would provide energy via the transformer T1, and so the energy is stored in the starting capacitor C2 via the rectifier diode D1 and is stored in the inductor L and the output filter capacitor C3 via the rectifier diode D2. When the transistor switch Q1 is turned off, the energy stored in starting capacitor C2 would be utilized to provide power to the pulse width modulator PWM to have the pulse width modulator PWM continuously operate, and the energy stored in inductor L would be released to the output filter capacitor C3 via the rectifier diode D3.

However, the rectifier diodes D2 and D3 are configured with forward bias voltages when the current passing through, which may cause energy loss. Therefore, there are also prior arts that use transistor switches to replace the rectifier diodes D2 and D3 to reduce energy loss.

Please referring to FIG. 2, which is a schematic diagram showing a forward synchronous converter of the prior art. The forward synchronous converter shown in FIG. 2 utilizes transistor switches Q2 and Q3 to replace the rectifier diodes D2 and D3 of FIG. 1, respectively. A synchronous rectifying controller 12 is utilized to control the on-off time of the transistor switches Q2 and Q3 according to the voltage drop VD at the secondary side of transformer T1 and the dead time setting signals S1 and S2.

FIG. 3 is a timing diagram showing the signals generated by the forward synchronous converter of FIG. 2 under continuous current mode (CCM). Please referring to FIGS. 2 and 3, Voltage levels of the two terminals of the secondary side of transformer T1 are V1 and V2, respectively. When the synchronous rectifying controller 12 detects that the secondary side terminal voltage V1 of the transformer T1 is rising, it will generate a first synchronous signal SG1 to turn on the transistor switch Q2. Then, the current will flow from one secondary side terminal of transformer T1 with the terminal voltage V1, through the inductor L, the output filter capacitor C3, the transistor switch Q2, to the other secondary side terminal of transformer T1 with the terminal voltage V2. The synchronous rectifying controller 12 turns off the transistor switch Q2 a dead time period DT1 before turn-on time period Ton is ended according to the dead time setting signal S1. Once the transistor switch Q2 has been turned off and the dead time period DT1 has passed, the synchronous rectifying controller 12 will generate a second synchronous signal SG2 to turn on the transistor switch Q3. Then, the energy stored in the inductor L will be output via the output filter capacitor C3 and the transistor switch Q3. The synchronous rectifying controller 12 turns off the transistor switch Q3 a dead time period DT2 before the turn-off time period Toff is ended according to the dead time setting signal S2. The purpose of setting the dead time periods DT1 and DT2 is to avoid the transistor switches Q2 and Q3 to be turned on at the same time. While within the dead time periods DT1 and DT2, the secondary side current of the transformer T1 can flow through the body diodes (not shown) of the transistor switches Q2 and Q3.

However, in FIG. 3, the method of turning off the transistor switches Q2 and Q3 earlier by a predetermined time period to achieve the setting of dead time periods DT1 and DT2 has a drawback that while under discontinuous current mode (DCM), the method is prone to have reverse current occurring. Please reference FIG. 4, which is a timing diagram showing the signals of the forward synchronous converter of FIG. 2 operated under discontinuous current mode. Under the discontinuous current mode, before the transistor switch Q1 has been turned on by the pulse width modulator. PWM of the primary side of the transformer T1 in the next cycle, the energy stored in inductor L has been totally released. Therefore, the energy stored in the output filter capacitor C3 would be output in reverse to the inductor L to generate the reverse current and there shows a period A in the timing diagram of FIG. 4 that the terminal voltage V2 is less than 0 volt. When reverse current occurs; not only would the output voltage VO become unstable, but there would also be unnecessary energy loss.

### SUMMARY OF THE INVENTION

Due to the drawbacks of prior arts, the present invention proposes a synchronous rectifying apparatus suitable for use in a forward synchronous converter, wherein the synchronous rectifying apparatus detects the output voltage of the forward synchronous converter in order to determine the operating condition of the forward synchronous converter (i.e. Under the Discontinuous Current Mode or at the boundary between Discontinuous Current Mode and the Continuous Current Mode). Furthermore, when the forward synchronous converter enters discontinuous current mode (DCM), the synchronous rectifying apparatus of the present invention can cease the switching of the synchronous rectifying transistor switch to avoid the problem of reverse current.

The synchronous rectifying apparatus of the present invention includes a condition detection unit and a synchronous rectifying controller. The condition detection unit is coupled to the secondary side of the forward synchronous converter and is utilized to determine the operating condition of the forward synchronous converter according to the rising slope of the secondary side voltage of the forward synchronous converter. When the forward synchronous converter is operating under discontinuous current mode or operating at the boundary between discontinuous current mode and continuous current mode (CCM), rising slope of the secondary side voltage will be lower than a predetermined value. At this time, the condition detection unit may output a reset signal. The synchronous rectifying controller is coupled to the condition detection unit and the secondary side of the forward synchronous converter and is utilized to control the switching of a first rectifying switch and a second rectifying switch of the forward synchronous converter according to the secondary side voltage of the forward synchronous converter, a first dead time setting signal, and a second dead time setting signal. In addition, the synchronous rectifying controller may turn off the second rectifying switch for a predetermined time period so as to prevent the problem of reverse current from happening.

Furthermore, the forward synchronous converter of the present invention includes a transforming unit, a first switch, a pulse width modulator, a synchronous rectifying switching unit, and the above mentioned synchronous rectifying apparatus. The transforming unit has a primary side and a secondary side, wherein the primary side is coupled to an input power source. The transforming unit converts an input voltage from the input power source into an output voltage output by the secondary side of the transforming unit. The first switch is coupled to the primary side of the transforming unit. The pulse width modulator is utilized to control the switching of the first switch according to a detection signal indicative of the output voltage. The synchronous rectifying switching unit includes a first rectifying switch and a second rectifying switch and is coupled to the secondary side of the transforming unit to rectify the output voltage. The above mentioned synchronous rectifying apparatus is coupled to the secondary side of the transforming unit and is utilized to determine the operating condition of the forward synchronous converter according to the rising slope of the output voltage of the transforming unit. When the forward synchronous converter is operating under discontinuous current mode or operating at the boundary between discontinuous current mode and the continuous current mode, the rising slope of the secondary side voltage will be lower than a predetermined value. Then, the synchronous rectifying apparatus will enforce the second rectifying switch to be turned off for a predetermined time period so as to prevent the problem of reverse current from happening.

As described above, the present invention proposes a synchronous rectifying apparatus suitable for use in a forward synchronous converter, wherein the forward synchronous apparatus will determine if the forward synchronous converter is operating under discontinuous current mode (DCM) or operating at the boundary between discontinuous current mode (DCM) and the continuous current mode (CCM) according to the secondary side voltage rising slope of the forward synchronous converter. The second rectifying switch would be turned off for a predetermined time period under the instance of the two above mentioned operation conditions to prevent the problem of reverse current from happening and so as to improve the unstable output voltage and energy loss conditions caused by the reverse current.

The above-mentioned summary and subsequent detailed descriptions as well as appended drawings are all illustrations of approaches, means and effects adopted by the present invention to achieve the prescribed purposes. Other objectives and advantages related to, the present invention will be further elucidated in the following specification and diagrams.

### BRIEF DESCRIPTION OF THE DRAWINGS

FIG. 1 is a schematic diagram showing a forward converter of the prior art;

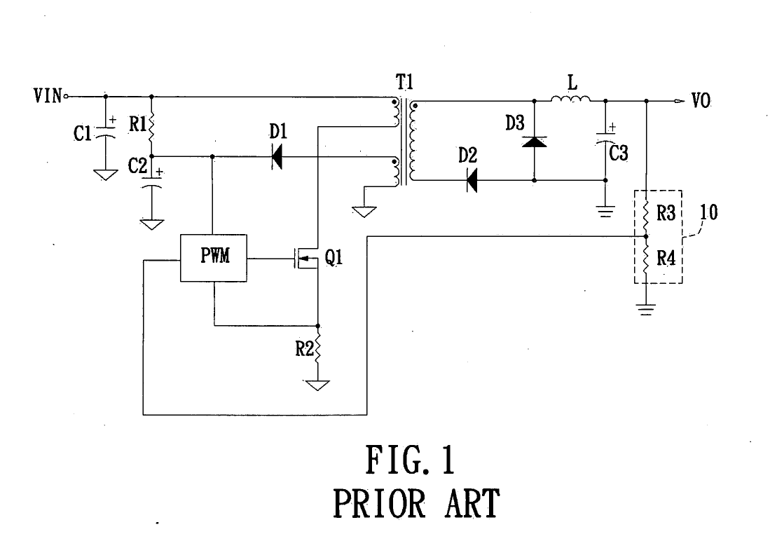

FIG. 2 is a schematic diagram showing a forward synchronous converter of the prior art;

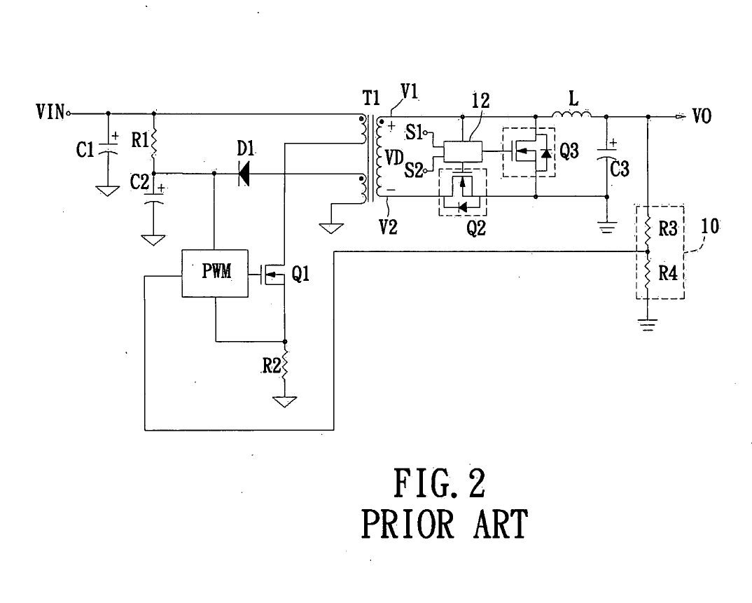

FIG. 3 is a timing diagram showing the signals generated by the forward synchronous converter operated under continuous current mode (CCM) according to prior art;

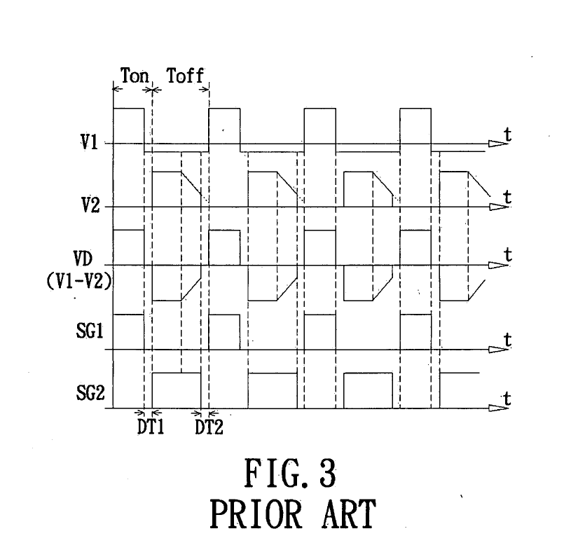

FIG. 4 is a timing diagram showing the signals generated by the forward synchronous converter operated under discontinuous current mode (DCM) according to prior art;

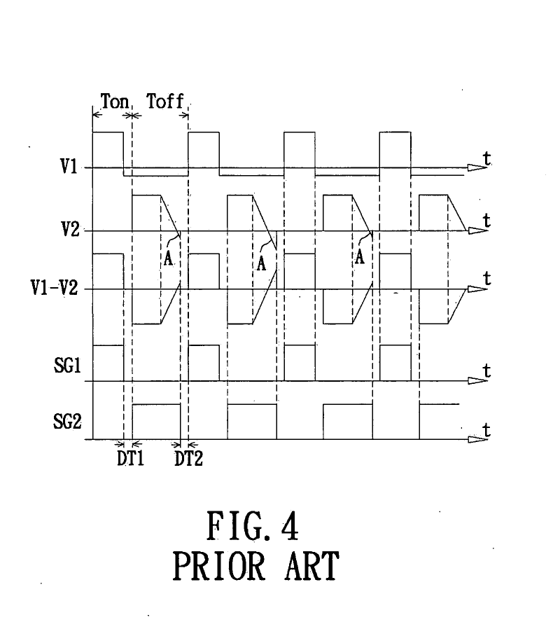

FIG. 5 is a schematic diagram showing a forward synchronous converter of the present invention;

FIG. 6 is a schematic diagram showing a condition detection unit of the present invention;

FIG. 7 is a timing diagram showing the operation of the condition detection unit in accordance with the present invention.

### DETAILED DESCRIPTION OF THE PREFERRED EMBODIMENTS

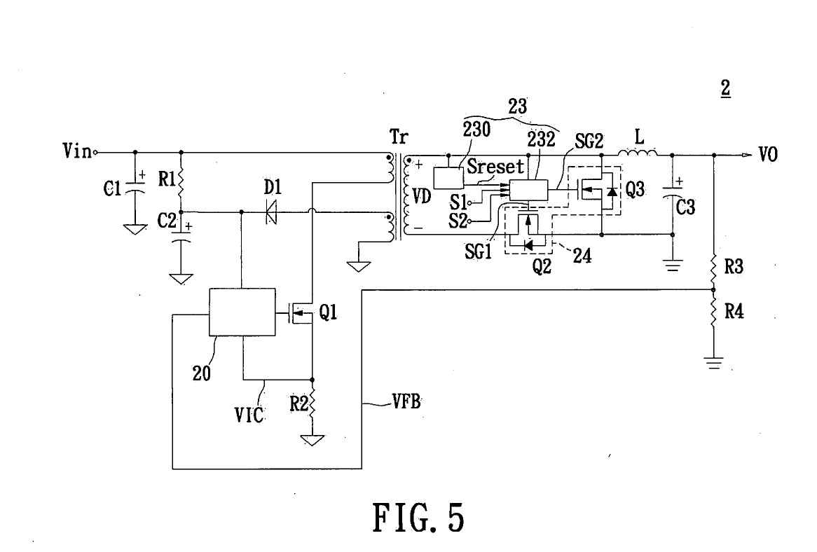

Please referring to FIG. 5, which is a schematic diagram showing a forward synchronous converter of the present invention, the forward synchronous converter 2 includes a transforming unit Tr, a first switch Q1, a pulse width modulator 20, a synchronous rectifying switching unit 24, and a synchronous rectifying apparatus 23.

The transforming unit Tr has a primary side and a secondary side. The primary side is coupled to an input power source Vin. The transforming unit Tr converts an input voltage from the input power source Vin into an output voltage VD output by the secondary side of the transforming unit Tr. The first rectifying switch Q1 is coupled to the primary side of the transforming unit Tr. The pulse width modulator 20 controls the switching of the first switch Q1 according to a feedback voltage signal VFB indicative of the output voltage VO of the forward synchronous converter 2 and a current detection signal VIC indicative of current flowing through the first switch Q1. The synchronous rectifying switching unit 24 includes a first rectifying switch Q2 and a second rectifying switch Q3, and both the first rectifying switch Q2 and the second rectifying switch Q3 are transistor switches. The first rectifying switch Q2 of the synchronous rectifying switching unit 24 is coupled to the secondary side of the transforming unit Tr so as to establish a forward current path for the forward synchronous converter 2. And the second rectifying switch Q3 of the synchronous rectifying switching unit 24 is connected to the secondary side of the transforming unit Tr in parallel so as to establish a current release path for the inductor L of the forward synchronous converter 2.

The synchronous rectifying apparatus 23 includes a condition detection unit 230 and a synchronous rectifying controller 232. When the synchronous rectifying controller 232 detects the rising of the secondary side voltage VD of the transforming unit Tr, it will generate a first synchronous signal SG1 to turn on of the first rectifying switch Q2. Meanwhile, a current is generated, flowing from a terminal of the secondary side of the transforming unit Tr (i.e. the positive terminal of the secondary side of the transforming unit Tr), through the inductor L, the output filter capacitor C3, the first rectifying switch Q2, and to the other terminal of the secondary side of the transforming unit Tr (i.e. the negative end of the secondary side of the transforming unit Tr). In addition, according to the first dead time setting signal S1, the synchronous rectifying controller 232 may turn off the first rectifying switch Q2 one dead time period DT1 before the turn-on time period Ton is ended.

Once the first rectifying switch Q2 has been turned off and the dead time period DT1 has passed, the synchronous rectifying controller 232 will generate a second synchronous signal SG2 to turn on the second rectifying switch Q3. At this time, the energy stored in the inductor L will be output via the path along the output filter capacitor C3 and the second rectifying switch Q3. In addition, according to the second dead time setting signal S2, the synchronous rectifying controller 232 will turn off the second rectifying switch Q3 one dead time period DT2 before the turn-off time period Toff is ended. The purpose of setting the dead time periods DT1 and DT2 is to avoid the rectifying switches Q2 and Q3 to be turned-on at the same time. While within the dead time periods DT1 and DT2, the secondary side current of the transforming unit Tr can flow through the body diodes (not shown) of the first rectifying switch Q2 and the second rectifying switch Q3.

The condition detection unit 230 is coupled to the secondary side of the transforming unit Tr and is utilized to determine the operating condition of the forward synchronous converter 2 according to the rising slope of the secondary side voltage VD of the transforming unit Tr. When the forward synchronous converter 2 is operating under discontinuous current mode (DCM) or operating at the boundary between discontinuous current mode and continuous current mode (CCM), the condition detection unit 230 may generate a reset signal Sreset. At this time, when the synchronous rectifying controller 232, which is coupled to the secondary side of the transforming unit Tr, the condition detection unit 230, and the synchronous rectifying switching unit 24, receives the reset signal Sreset, the synchronous rectifying controller 232 may turn off the second rectifying switch Q3 of the synchronous rectifying switching unit 24 for at least one cycle to prevent reverse current from happening while the forward synchronous converter 2 is operating under discontinuous current mode or while at the boundary between discontinuous current mode and continuous current mode. The above mentioned cycle may be the operating cycle of the forward synchronous converter 2 (i.e. the operating cycle of the pulse width modulator 20). In other words, the predetermined turn-off time period of the second rectifying switch Q3 is longer than one operating cycle of the forward synchronous converter 2.

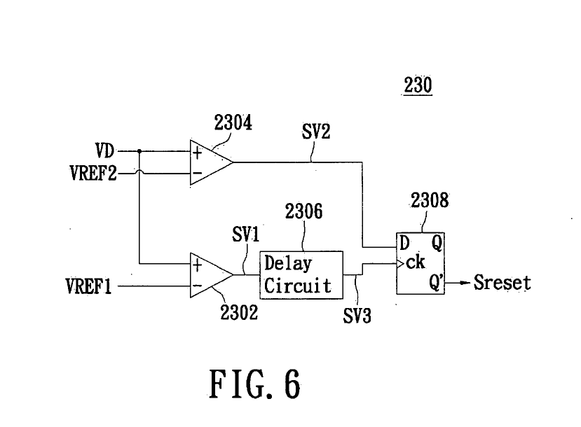

Please reference FIG. 6, which is a schematic diagram showing a condition detection unit of the present invention. The condition detection unit 230 of the present invention includes a first voltage detector 2302, a second voltage detector 2304, a delay circuit 2306, and a D register 2308. The first voltage detector 2302 is utilized to compare the output voltage VD of the secondary side of transforming unit Tr with a first reference voltage VREF1, and output a first detection signal SV1 according to the comparing result. The second voltage detector 2304 is utilized to compare the output voltage VD of the secondary side of transforming unit Tr with a second reference voltage VREF2, and output a second detection signal SV2 according to the comparing result. The voltage level of the second reference voltage VREF2 is higher than that of the first reference voltage VREF1. According to the above descriptions, it is understood that the first voltage detector 2302 and the second voltage detector 2304 form an analog/digital converter. In other words, the analog/digital converter may output a plurality of detection signals (i.e. SV1 and SV2) according to the secondary side voltage VD of the transforming unit Tr.

Accommodating practical applications, the condition Detection Unit 230 may use two or more voltage detectors to output multiple detection signals for detecting the operating condition of the forward synchronous converter 2 more accurately.

Please referring to FIG. 6 once more, the delay circuit 2306 is coupled to the first voltage detector 2302 and is utilized for delaying the first detection signal SV1 to output a delayed detection signal SV3. In addition, the D register 2308 has a data input end D coupled to the second voltage detector 2304 in order to receive the second detection signal SV2, and a clock input end CK coupled to the delay circuit 2306 in order to receive the delayed detection signal SV3. The D register 2308 may temporary store the second detection signal SV2 according to the delayed detection signal SV3 and generate a reset signal Sreset at the output end Q′ of the D register 2308 based on the stored second detection signal SV2. According to the above descriptions, it is understood that the delay circuit 2306 and the D register 2308 form a digital processor. In other words, the digital processor is coupled to the analog/digital converter for processing the plurality of detection signals (i.e. SV1 and SV2) in order to output the reset signal Sreset.

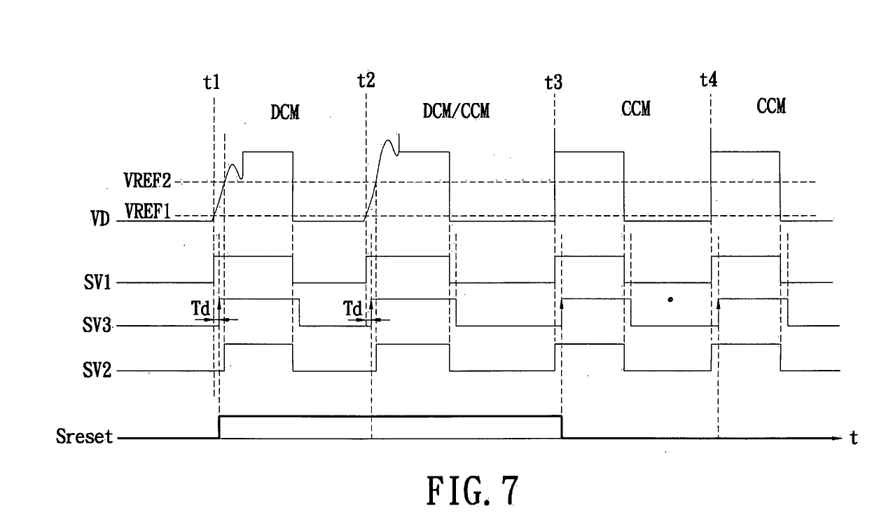

FIG. 7 shows a timing diagram depicting the operation of the condition detection unit 230 of the present invention. Referring to FIG. 7 in conjunction with FIG. 6, the first voltage detector 2302 detects the rising edge of the secondary side voltage VD of the transforming unit Tr, compares the detected output voltage VD with the first reference voltage VREF1, and then generates the first detection signal SV1 according to the comparing result. The second voltage detector 2304 detects the rising edge of the secondary side voltage VD of the transforming unit Tr, compares the detected output voltage VD with the second reference voltage VREF2, and then generates the second detection signal SV2 according to the comparing result. The delay circuit 2306 delays the timing of the first detection signal SV1 for a delay time period Td to generate the delayed detection signal SV3.

Please referring to FIG. 7 in conjunction with FIG. 6 once more, during time t1 to t2, the forward synchronous converter 2 is operating under discontinuous current mode (DCM). At this time, rising slope of the secondary side voltage VD of the transforming unit Tr is smaller than that under continuous current mode (CCM). Thus, the first detection signal SV1, the delayed detection signal SV3, and the second detection signal SV2 are switched from low level to high level in a serial. In addition, the leading edge of the delayed detection signal SV3 triggers the D register 2308 to store the low level second detection signal SV2 and to have the output end Q′ of the D register 2308 show a high level to indicative of the output of the reset signal Sreset.

Please referring to FIG. 7 in conjunction with FIG. 6 once more, during time t2 to t3, the forward synchronous converter 2 is operating at the boundary between discontinuous current mode and continuous current mode (DCM/CCM). At this time, rising slope of the secondary side voltage VD of the transforming unit Tr is slightly larger than that under discontinuous current mode during time t1 to t2. Thus the first detection signal SV1, the delayed detection signal SV3, and the second detection signal SV2 are switched from low level to high level in a serial, respectively. In addition, the leading edge of the delayed detection signal SV3 triggers the D register 2308 to store the low level second detection signal SV2 and to have the output end Q′ of the D register 2308 show a high level to represent the output of the reset signal Sreset.

Please referring to FIG. 7 in conjunction with FIG. 6 once more, during time t3-t4, the forward synchronous converter 2 is operating under continuous current mode (CCM). At this time, rising slope of the secondary side voltage VD of the transforming unit Tr is quite large. Thus, the first detection signal SV1 and the second detection signal SV2 are nearly simultaneously switched from low level to high level, and then the delayed detection signal SV3 is followed to switch from low level to high level. Therefore, the leading edge of the delayed detection signal SV3 triggers the D register 2308 to store the high level second detection signal SV2 and to have the output end Q′ of the D register 2308 show a low level to indicative of no reset signal Sreset has been generated.

In conclusion, referring to FIG. 7, during time t1-t2 and t2-t3, when the forward synchronous converter 2 is operating under discontinuous current mode (DCM) or at the boundary between discontinuous current mode (DCM) and continuous current mode (CCM), the condition detection unit 230 may output the reset signal Sreset, whereas, during time t3-t4, when the forward synchronous converter 2 is operating under continuous current mode (CCM), no reset signal Sreset has been generated.

Please referring to FIG. 5, when the forward synchronous converter 2 is operating under discontinuous current mode (DCM) or at the boundary between discontinuous current mode (DCM) and continuous current mode (CCM), the synchronous rectifying controller 232 receives the reset signal Sreset and turns off the second rectifying switch Q3 of the synchronous rectifying switching unit 24 for a predetermined time period (at least one cycle). During this predetermined time period, the second rectifying switch Q3 is not switched by the second synchronous signal SG2. Thus, the problem of reverse current can be avoided.

As described above, the synchronous rectifying apparatus proposed by the present invention is suitable for use in a forward synchronous converter, wherein the synchronous rectifying apparatus detects the rising slope of the secondary side output voltage signal of the forward synchronous converter so as to determine whether of the forward synchronous converter is operating under the discontinuous current mode or at the boundary between the discontinuous current mode and the continuous current mode. As the forward synchronous converter is operating under the above mentioned conditions, the synchronous rectifying apparatus will enforce the second rectifying switch to be turned off for a predetermined time period so as to prevent the problem of reverse current from happening, and thus improve the unstable output voltage and energy loss caused by the reverse current.

While the present invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A synchronous rectifying apparatus, coupled to a forward synchronous converter, the forward synchronous converter including a transforming unit having a primary side and a secondary side, wherein the secondary side is coupled to a first rectifying switch and a second rectifying switch, and the synchronous rectifying apparatus comprises:
a condition detection unit, coupled to the secondary side of the transforming unit, determining operating condition of the forward synchronous converter based on a rising slope of a secondary side voltage, and outputting a reset signal according to the determined operating condition; and
a synchronous rectifying controller, coupled to thee condition detection unit, and generating a first synchronous signal and a second synchronous signal to control the first rectifying switch and the second rectifying switch, respectively;
wherein as the synchronous rectifying controller receives the reset signal, the second rectifying switch is turned off for a predetermined time period.

2. The synchronous rectifying apparatus according to claim 1, wherein the synchronous rectifying controller controls the first rectifying switch and the second rectifying switch according to the secondary side voltage of the transforming unit, a first dead time setting signal, and a second dead time setting signal.

3. The synchronous rectifying apparatus according to claim 1, wherein the condition detection unit comprises:
an analog/digital converter, which outputs a plurality of detection signals according to the secondary side voltage of the transforming unit; and
a digital processor, coupled to the analog/digital converter for processing the plurality of detection signals to selectively output the reset signal.

4. The synchronous rectifying apparatus according to claim 3, wherein the analog/digital converter comprises:
a first voltage detector, which compares the secondary side voltage of the transforming unit with a first reference voltage to output a first detection signal; and
a second voltage detector, which compares the secondary side voltage of the transforming unit with a second reference voltage to output a second detection signal;
wherein a voltage level of the second reference voltage is higher than that of the first reference voltage.

5. The synchronous rectifying apparatus according to claim 4, wherein the digital processor comprises:
a delay circuit, coupled to the first voltage detector for delaying timing of the first detection signal to output a delayed detection signal; and
a D register, having a data input end, a clock input end, and an output end, wherein the data input end is coupled to the second voltage detector to receive the second detection signal, the clock input end is coupled to the delay circuit to receive the delayed detection signal, and the D register is utilized to selectively output the reset signal via the output end according to the second detection signal and the delayed detection signal.

6. The synchronous rectifying apparatus according to claim 1, wherein the predetermined time period is longer than one operating cycle of the forward synchronous converter.

7. The synchronous rectifying apparatus according to claim 1, wherein the first rectifying switch is utilized to generate a current path for storing energy in an inductor coupled to the secondary side of the transforming unit, and the second rectifying switch is utilized to generate a current for releasing energy from the inductor.

8. A forward synchronous converter, comprises:
a transforming unit, having a primary side and a secondary side, wherein the primary side is coupled to an input power source, and the transforming unit converts an input voltage from the input power source into an output voltage output by the secondary side of the transforming unit;
a first switch, coupled to the primary side of the transforming unit;
a pulse width modulator, utilized for controlling the first switch according to a detection signal indicative of the output voltage;
a synchronous rectifying switching unit, including a first rectifying switch and a second rectifying switch, wherein the synchronous rectifying switching unit is coupled to the secondary side of the transforming unit in order to rectify the output voltage;
a condition detection unit, coupled to the secondary side of the transforming unit, determining the operating condition of the forward synchronous converter according to a rising slope of a secondary side voltage of the transforming unit, and outputting a reset signal according to the operating condition; and
a synchronous rectifying controller, coupled to the condition detection unit and the synchronous rectifying switching unit, turning off of the second rectifying switch for a predetermined time period according to the reset signal.

9. The forward synchronous converter according to claim 8, wherein the synchronous rectifying controller is coupled to the secondary side of the transforming unit, and controls the first rectifying switch and the second rectifying switch according to the secondary side voltage of the transforming unit, a first dead time setting signal, and a second dead time setting signal.

10. The forward synchronous converter according to claim 8, wherein the condition detection unit comprises:
an analog/digital converter, which outputs a plurality of detection signals according to the secondary side voltage of the transforming unit; and
a digital processor, coupled to the analog/digital converter for processing the plurality of detection signals to selectively output the reset signal.

11. The forward synchronous converter according to claim 10, wherein the analog digital converter comprises:
a first voltage detector, which compares the secondary side voltage of the transforming unit with a first reference voltage to output a first detection signal; and
a second voltage detector, which compares the secondary side voltage of the transforming unit with a second reference voltage to output a second detection signal;
wherein a voltage level of the second reference voltage is higher than that of the first reference voltage.

12. The forward synchronous converter according to claim 11, wherein the digital processor comprises:
a delay circuit, coupled to the first voltage detector for delaying the timing of the first detection signal to output a delayed detection signal; and
a D register, having a data input end, a clock input end, and an output end, wherein the data input end is coupled to the second voltage detector to receive the second detection signal, the clock input end is coupled to the delay circuit to receive the delayed detection signal, and the D register is utilized to selectively output the reset signal via the output end according to the second detection signal and the delayed detection signal.

13. The forward synchronous converter according to claim 8, wherein the predetermined time period is longer than one operating cycle of the forward synchronous converter.

14. The forward synchronous converter according to claim 8, wherein the first rectifying switch is utilized to generate a current path for storing energy in an inductor coupled to the secondary side of the transforming unit, and the second rectifying switch is utilized to generate a current for releasing energy from the inductor.
